(19) United States
(12) Patent Application Publication
(10) Pub. No.: US 2025/0174807 A1
(43) Pub. Date: May 29, 2025

(54) ELECTRICITY STORAGE APPARATUS AND ELECTRICITY STORAGE SYSTEM

(71) Applicant: TOYOTA JIDOSHA KABUSHIKI KAISHA, Aichi-ken (JP)

(72) Inventors: Kodai SHINTANI, Toyota-shi (JP); Satoshi MORIOKA, Okazaki-shi (JP); Seita IWAHASHI, Handa-shi (JP); Yuusuke NOSE, Toyohashi-shi (JP); Masahiro YAMADA, Kariya-shi (JP); Takayuki HIROSE, Kariya-shi (JP); Tomohiro NAKAMURA, Kariya-shi (JP)

(21) Appl. No.: 18/810,510

(22) Filed: Aug. 21, 2024

(30) Foreign Application Priority Data
Nov. 29, 2023 (JP) 2023-201456

(51) Int. Cl. H01M 50/30; H01M 10/48; H01M 50/124

(52) U.S. Cl. CPC H01M 50/30; H01M 10/48; H01M 50/1245

(57) ABSTRACT

An electricity storage apparatus includes: an electricity storage module having a stacked electrode body; an exterior body that houses the electricity storage module and forms a sealed inner space between the exterior body and the electricity storage module; and first piping that discharges gas contained in the inner space to an outside of the electricity storage apparatus. The air pressure of the inner space of the electricity storage apparatus is maintained to be a negative pressure with respect to the air pressure of an outer space of the electricity storage apparatus by a suction apparatus that suctions gas via the first piping.

### CROSS-REFERENCE TO RELATED APPLICATION

This application claims priority to Japanese Patent Application No. 2023-201456 filed on Nov. 29, 2023, incorporated herein by reference in its entirety.

### BACKGROUND

### 1. Technical Field

The present disclosure relates to an electricity storage apparatus and an electricity storage system including a plurality of electricity storage apparatuses.

### 2. Description of Related Art

Hitherto, various electricity storage apparatuses have been known. Japanese Unexamined Patent Application Publication No. 2004-134210 (JP 2004-134210 A) discloses a bipolar stack-type battery as one example of an electricity storage apparatus. In the stack-type battery, sheet-like electrodes are stacked across an electrolyte layer. In the stack-type battery, the electrodes are stacked in outermost layers of a stack such that current collectors included in the electrodes are exposed to the outside of the battery in the stacking direction of the electrodes and function as terminals.

In detail, each of the current collectors of the two electrodes in the outermost layers is covered by a laminate sheet in which an opening is provided in the center. Four edges of each laminate sheet are sealed, and a rim of an opening of each laminate sheet is attached to a current collector by seal resin. As a result, four edges of the electrolyte layers and bipolar electrodes are depressurized and hermetically sealed. As each laminate sheet, a polymeric metal composite film in which a heat-fusible resin film, a metal foil, and a resin film that has rigidity are stacked in the stated order is used.

### SUMMARY

In JP 2004-134210 A, a pressure difference is generated between an inner space and an outer space of the stack-type battery by depressurization as described above. In JP 2004-134210 A, a binding force is applied to the stacked electrodes (a stacked electrode body) by the pressure difference.

In a stack-type battery such as that described in JP 2004-134210 A, there is a risk that the pressure difference between the inner space and the outer space of the stack-type battery decreases as a result of air entering a joining portion of the laminate sheets. In this case, a suitable binding force cannot be applied to the stacked electrode body.

The present disclosure provides an electricity storage apparatus capable of continuing to apply a suitable binding force to a stacked electrode body even when air enters an inner space of the electricity storage apparatus from an outer space of the electricity storage apparatus and an electricity storage system including a plurality of electricity storage apparatuses.

According to an aspect of the present disclosure, an electricity storage apparatus includes: an electricity storage module having a stacked electrode body; an exterior body that houses the electricity storage module and forms a sealed inner space between the exterior body and the electricity storage module; and first piping that discharges gas contained in the inner space to an outside of the electricity storage apparatus. The air pressure of the inner space of the electricity storage apparatus is maintained to be a negative pressure with respect to the air pressure of an outer space of the electricity storage apparatus by a suction apparatus that suctions gas via the first piping.

According to such configuration, even when air enters the inner space, the air in the inner space is suctioned by the first piping and the suction apparatus, and hence the air pressure of the inner space does not become a negative pressure with respect to the air pressure of the outer space. Therefore, it becomes possible to continue to apply a suitable binding force to the stacked electrode body even when air enters the inner space of the electricity storage apparatus from the outer space of the electricity storage apparatus.

The electricity storage apparatus may further include a structure body housed in the exterior body. The electricity storage module has a main surface and a peripheral surface perpendicular to the main surface. The structure body has an outer front surface and an inner front surface on the peripheral surface side of the outer front surface and is disposed in a state of facing the peripheral surface. The exterior body includes a laminate sheet body disposed so as to cover the outer front surface. The inner space is formed between the inner front surface and the peripheral surface by sealing by the laminate sheet body. A through-hole that passes through the structure body from the outer front surface to the inner front surface is formed in the structure body. The first piping reaches the inner space via the through-hole.

According to such configuration, the air in the inner space can be suctioned via the first piping. Cases in which the first piping is closed in the exterior body can be reduced by the structure body.

The electricity storage apparatus may further include a suction apparatus. The suction apparatus includes: a pump that suctions the gas contained in the inner space via the first piping; a control apparatus that controls an operation of the pump; and a pressure gauge that measures an air pressure in the first piping. The control apparatus controls the operation of the pump such that the air pressure measured by the pressure gauge becomes equal to or less than a threshold value lower than the air pressure of the outer space.

According to such configuration, the air pressure of the inner space can be maintained to be equal to or less than the threshold value lower than the air pressure of the outer space.

According to another aspect of the present disclosure, an electricity storage system includes a plurality of the electricity storage apparatuses described above. The electricity storage system further includes the suction apparatus described above. The suction apparatus includes: a pump; second piping that connects the first piping of each of the electricity storage apparatuses and the pump to each other; a control apparatus that controls an operation of the pump; and a pressure gauge that measures an air pressure in the second piping. The pump is able to suction the gas contained in the inner space of each of the electricity storage apparatuses via the first piping and the second piping. The control apparatus controls the operation of the pump such that the air pressure measured by the pressure gauge becomes equal to or less than a threshold value lower than the air pressure of the outer space.

According to such configuration, the inner space of each of the electricity storage apparatuses can be simultaneously depressurized by one suction pump. Therefore, the air pressure of the inner space of each of the electricity storage apparatuses can be maintained to be equal to or less than the threshold value lower than the air pressure of the outer space.

According to the present disclosure, it becomes possible to continue to apply a suitable binding force to the stacked electrode body even when air enters the inner space of the electricity storage apparatus from the outer space of the electricity storage apparatus.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a stack-type battery;

FIG. 2 is a sectional view taken along line II-II shown in FIG. 1;

FIG. 3 is a sectional view taken along line III-III shown in FIG. 1;

FIG. 4 is a perspective view of a structure body;

FIG. 5A is a view for describing a manufacturing method of a first laminate sheet portion;

FIG. 5B is a view for describing the manufacturing method of the first laminate sheet portion;

FIG. 5C is a view for describing the manufacturing method of the first laminate sheet portion;

FIG. 5D is a view for describing the manufacturing method of the first laminate sheet portion;

FIG. 5E is a view for describing the manufacturing method of the first laminate sheet portion;

FIG. 5F is a view for describing the manufacturing method of the first laminate sheet portion;

FIG. 5G is a view for describing the manufacturing method of the first laminate sheet portion;

FIG. 6A is a view for describing a method of manufacturing the stack-type battery by an electricity storage module and an exterior body;

FIG. 6B is a view for describing the method of manufacturing the stack-type battery by the electricity storage module and the exterior body;

FIG. 6C is a view for describing the method of manufacturing the stack-type battery by the electricity storage module and the exterior body;

FIG. 6D is a view for describing the method of manufacturing the stack-type battery by the electricity storage module and the exterior body; and

FIG. 7 is a view for describing an electricity storage system.

### DETAILED DESCRIPTION OF EMBODIMENTS

An embodiment of the disclosure is described in detail below with reference to the drawings. In the embodiment described below, the same or common parts are denoted by the same reference characters in the drawings and description thereof is not repeated.

As one example of an electricity storage apparatus, a stack-type battery is described as an example below. The stack-type battery is mounted on electrified vehicles such as a hybrid electric vehicle that travels with use of a motive power of at least one of a motor and an engine and an electric vehicle that travels by a driving force acquired by electrical energy.

The stacking direction of electrodes in the stack-type battery is also referred to as a “DR3 direction” below. A direction that is perpendicular to the stacking direction and is the short direction of the stack-type battery is also referred to as a “DR1 direction”. A direction that is perpendicular to the stacking direction and is the longitudinal direction of the stack-type battery is also referred to as a “DR2 direction”. The DR1 direction, the DR2 direction, and the DR3 direction are orthogonal to each other.

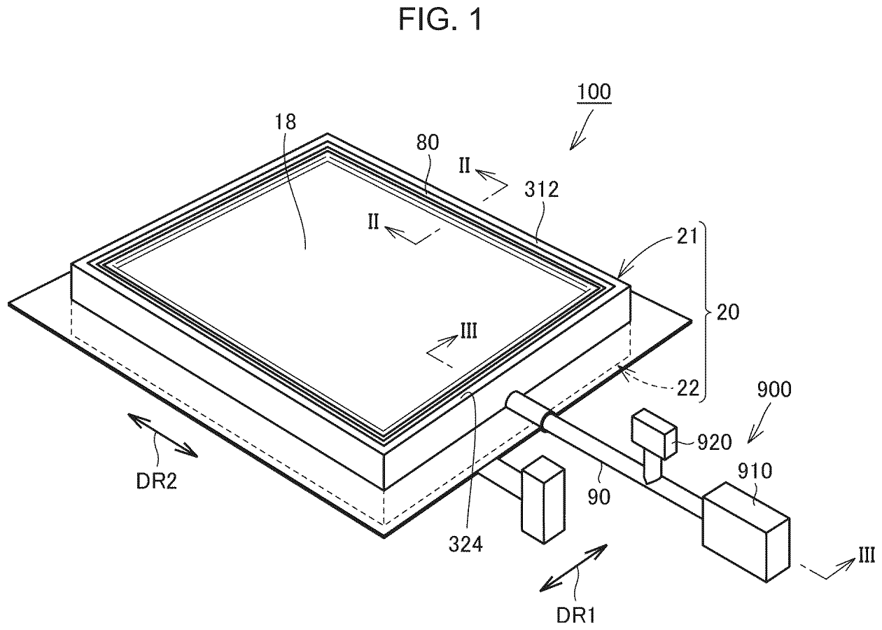

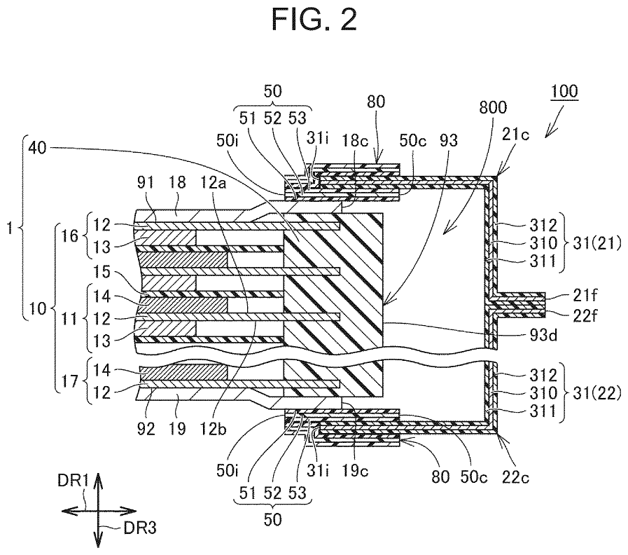

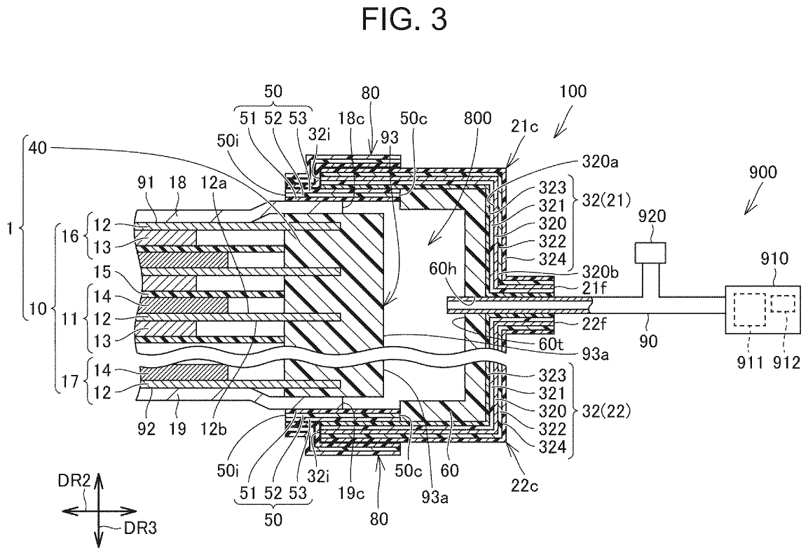

FIG. 1 is a perspective view of a stack-type battery 100 according to an embodiment of the present disclosure. FIG. 2 is a sectional view taken along line II-II shown in FIG. 1. FIG. 3 is a sectional view taken along line III-III shown in FIG. 1. With reference to FIG. 1 to FIG. 3, the stack-type battery 100 according to the present embodiment is described.

As shown in FIG. 1 to FIG. 3, the stack-type battery 100 includes an electricity storage module 1 having a resin sealing body 40 and a stacked electrode body 10 in which a plurality of electrodes (electrode plates 11) described later is stacked in the stacking direction, a structure body 60 (FIG. 3), an exterior body 20 that houses the electricity storage module 1 and the structure body 60, piping 90, and a suction apparatus 900. The exterior body 20 forms a sealed inner space 800 (see FIG. 2 and FIG. 3) between the exterior body 20 and the electricity storage module 1.

The suction apparatus 900 has a suction machine 910 and a pressure gauge 920. As shown in FIG. 3, the suction machine 910 has a suction pump 911 and a control apparatus 912 built therein.

The piping 90 is used to discharge gas contained in an inner space 800 of the stack-type battery 100 to the outside of the stack-type battery 100. The piping 90 is connected to the suction machine 910 and the pressure gauge 920. The piping 90 is connected to the suction machine 910. The piping 90 is inserted into the inner space 800. The piping 90 branches in the middle. The piping 90 has three end portions. A first end portion is connected to the suction machine 910. A second end portion is connected to the pressure gauge 920. A third end portion is inserted into the inside of the stack-type battery 100.

The electricity storage module 1 further has a first main surface 91, a second main surface 92 on the side opposite from the first main surface 91, and peripheral surfaces 93. The first main surface 91 and the second main surface 92 are end surfaces in the DR3 direction. The first main surface 91 and the second main surface 92 are parallel to each other. The first main surface 91 and the second main surface 92 are surfaces that spread in the DR1 direction and the DR2 direction. The first main surface 91 is a surface in contact with a first conductive plate 18 described later. The second main surface 92 is a surface in contact with a second conductive plate 19 described later.

The peripheral surfaces 93 are surfaces perpendicular to the first main surface 91 and the second main surface 92. In this example, the peripheral surfaces 93 are configured by four end surfaces 93a to 93d (see FIGS. 2, 3, and 7). Each of the end surfaces 93a to 93d is a side surface of the resin sealing body 40. In this example, each of the end surfaces 93a to 93d is a planar surface having a rectangular shape.

The exterior body 20 is electrically connected to a terminal end electrode of the stacked electrode body 10 described later and is provided such that current can be taken to the outside from the stacking direction. The exterior body 20 includes the first conductive plate 18, the second conductive plate 19, a first laminate sheet portion 21, a second laminate sheet portion 22, a resin sheet 50, and a resin sheet 80. The stack-type battery 100 is a secondary battery such as a lithium ion battery, for example.

The stacked electrode body 10 includes the plurality of electrode plates 11, a plurality of separators 15, a positive-electrode terminal end electrode 16, and a negative-electrode terminal end electrode 17. The plurality of electrode plates 11, the positive-electrode terminal end electrode 16, and the negative-electrode terminal end electrode 17 are stacked in the stacking direction (the DR3 direction in FIG. 2 and FIG. 3) via the separators 15.

The separators 15 are formed in a sheet-like manner. Examples of the separators 15 include a porous film formed by polyolefin resin such as polyethylene (PE) and polypropylene (PP) and a woven fabric or a non-woven fabric formed by polypropylene, methylcellulose, and the like. The separators 15 may be reinforced by a fluorinated vinylidene resin compound.

The plurality of electrode plates 11 is provided between the positive-electrode terminal end electrode 16 and the negative-electrode terminal end electrode 17. The electrode plates 11 are bipolar electrodes, for example. The electrode plates 11 include a current collector 12, a positive electrode layer 13, and a negative electrode layer 14.

The current collector 12 may contain at least one type selected from a group formed by aluminum (Al), stainless steel, nickel (Ni), chromium (Cr), platinum (Pt), niobium (Nb), iron (Fe), titanium (Ti), and zinc (Zn), for example. The current collector 12 may be obtained by applying a plating process to a front surface of a metallic foil.

The current collector 12 has a first surface 12a positioned on one side in the stacking direction and a second surface 12b positioned on the other side in the stacking direction. The negative electrode layer 14 is provided on the first surface 12a. The positive electrode layer 13 is provided on the second surface 12b.

The positive-electrode terminal end electrode 16 is positioned on one side in the stacking direction. The positive-electrode terminal end electrode 16 includes the current collector 12 and the positive electrode layer 13. Specifically, in the positive-electrode terminal end electrode 16, the negative electrode layer 14 and the positive electrode layer 13 are not provided on the first surface 12a of the current collector 12, and the positive electrode layer 13 is provided on the second surface 12b of the current collector 12. The first conductive plate 18 is disposed on the first surface 12a of the current collector 12 in the positive-electrode terminal end electrode 16. A central portion (a part other than a peripheral edge portion) of the first surface 12a of the current collector 12 in the positive-electrode terminal end electrode 16 configures a part of the first main surface 91. The first main surface 91 includes the central portion of the first surface 12a of the current collector 12 in the positive-electrode terminal end electrode 16 and an upper surface of the resin sealing body 40.

The negative-electrode terminal end electrode 17 is positioned on the other side in the stacking direction. The negative-electrode terminal end electrode 17 includes the current collector 12 and the negative electrode layer 14. Specifically, in the negative-electrode terminal end electrode 17, the negative electrode layer 14 is provided on the first surface 12a of the current collector 12, and the negative electrode layer 14 and the positive electrode layer 13 are not provided on the second surface 12b of the current collector 12. The second conductive plate 19 is disposed on the second surface 12b of the current collector 12 in the negative-electrode terminal end electrode 17. A central portion (a part other than a peripheral edge portion) of the second surface 12b of the current collector 12 in the negative-electrode terminal end electrode 17 configures a part of the second main surface 92. The second main surface 92 includes the central portion of the second surface 12b of the current collector 12 in the negative-electrode terminal end electrode 17 and a lower surface of the resin sealing body 40.

The positive electrode layer 13 is formed as a result of a positive-electrode active material being applied to the second surface 12b. As the positive-electrode active material, a material that can occlude and release charge carriers such as lithium ions can be employed, for example. Specifically, as the positive-electrode active material, a lithium ion composite metal oxide having a layered rock salt structure, metal oxide having a spinel structure, a polyanionic compound, and the like that can be used as a positive-electrode active material of a lithium ion secondary battery can be employed. Two or more types of positive-electrode active materials may be used together, and the positive-electrode active material may contain olivine-type lithium iron phosphate (LiFePO4), for example.

The negative electrode layer 14 is formed as a result of a negative-electrode active material being applied to the first surface 12a. As the negative-electrode active material, lithium, carbon, a metal compound, and an element that can be alloyed with lithium, a compound thereof, or the like, for example, can be employed.

In all of the plurality of electrode plates 11, the negative-electrode terminal end electrode 17, and the positive-electrode terminal end electrode 16, a peripheral edge portion of the current collector 12 is an uncoated region in which the positive electrode layer 13 and the negative electrode layer 14 are not provided.

The resin sealing body 40 is provided so as to seal the periphery of the stacked electrode body 10. Specifically, the resin sealing body 40 seals a cell space formed between two adjacent electrode plates 11. An electrolytic solution is injected into the cell space. The resin sealing body 40 is formed by curing resin members such as a hotmelt member, a thermoplastic resin, or a photocurable resin. The resin sealing body 40 is provided on the uncoated region described above.

The first conductive plate 18 and the second conductive plate 19 are provided so as to sandwich the stacked electrode body 10 in the stacking direction. Specifically, the first conductive plate 18 is disposed on the first surface 12a of the current collector 12 included in the positive-electrode terminal end electrode 16. In other words, the first conductive plate 18 is disposed on the first main surface 91 of the current collector 12 included in the positive-electrode terminal end electrode 16. The first conductive plate 18 is electrically connected to the positive-electrode terminal end electrode 16 by being disposed in abutment against the first surface 12a. The first conductive plate 18 functions as a positive-electrode terminal of the stack-type battery 100 by being electrically connected to the positive-electrode terminal end electrode 16.

The second conductive plate 19 is disposed on the second surface 12b of the current collector 12 included in the negative-electrode terminal end electrode 17. In other words, the second conductive plate 19 is disposed on the second main surface 92 of the current collector 12 included in the negative-electrode terminal end electrode 17. The second conductive plate 19 is electrically connected to the negative-electrode terminal end electrode 17 by being disposed in abutment against the second surface 12b. The second conductive plate 19 functions as a negative-electrode terminal of the stack-type battery 100 by being electrically connected to the negative-electrode terminal end electrode 17.

In the stack-type battery 100, current can be taken to the outside from the electricity storage module 1 housed in the inside via the first conductive plate 18 that functions as a positive-electrode terminal and the second conductive plate 19 that functions as a negative-electrode terminal without using a tab for taking out the current to the outside.

The first conductive plate 18 and the second conductive plate 19 have a rectangular shape having a plurality of corner portions. Peripheral edges of the first conductive plate 18 and the second conductive plate 19 are positioned on the resin sealing body 40.

In this example, the first conductive plate 18 and the second conductive plate 19 are aluminum (Al) plates. The first conductive plate 18 and the second conductive plate 19 are not limited thereto and may contain at least one type selected from a group formed by aluminum (Al), stainless steel, nickel (Ni), chromium (Cr), platinum (Pt), niobium (Nb), iron (Fe), titanium (Ti), and zinc (Zn). The current collector 12 may be obtained by applying a plating process to a front surface of a metallic foil.

The first laminate sheet portion 21 is joined to a peripheral edge of the first conductive plate 18. The first laminate sheet portion 21 is joined to the first conductive plate 18 in a state in which the resin sheet 50 is interposed between the first laminate sheet portion 21 and the peripheral edge of the first conductive plate 18. The second laminate sheet portion 22 is joined to a peripheral edge of the second conductive plate 19. The second laminate sheet portion 22 is joined to the second conductive plate 19 in a state in which the resin sheet 50 is interposed between the second laminate sheet portion 22 and the peripheral edge of the second conductive plate 19.

The resin sheet 50 causes the first conductive plate 18 and the first laminate sheet portion 21 to adhere to each other. The resin sheet 50 causes the second conductive plate 19 and the second laminate sheet portion 22 to adhere to each other. In this example, the resin sheet 50 is formed by a resin material having an insulation property. The resin sheet 50 is formed by a resin material that can be welded to the first conductive plate 18 and the second conductive plate 19. In this example, the resin sheet 50 is an insulation sealant film.

In detail, the resin sheet 50 has resin layers 51, 52, 53. The resin layer 51 is a layer on the inner side. The resin layer 53 is a layer on the outer side. The resin layer 52 is sandwiched between the resin layer 51 and the resin layer 53.

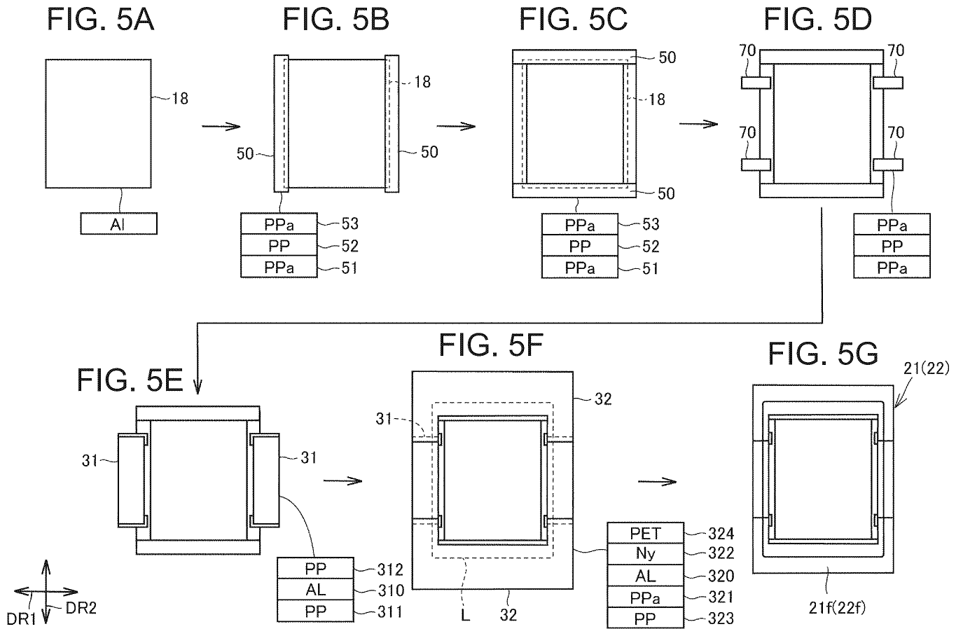

The resin layers 51, 53 are sealant resin layers. As also shown in FIG. 5B and FIG. 5C described later, the resin layers 51, 53 are acid modified PP (PPa) layers in this example. The resin layer 51 is thermally welded to the first conductive plate 18. The resin layer 52 is a layer of polypropylene (PP) in this example.

The type of the resin configuring each of the resin layers 51 to 53 is not limited to the above, and heat-fusible resin such as polyethylene, polypropylene, modified polyethylene, and modified polypropylene, for example, can be used, as appropriate.

The resin sheet 80 is provided as insulation measures. The resin sheet 80 is provided in order to prevent shorting of an outermost electrode via first and second metal layers 310, 320 (FIG. 2, FIG. 3) described later. In detail, the resin sheet 80 prevents shorting and liquid junction between the first and second metal layers 310, 320 (FIG. 2, FIG. 3) and the first conductive plate 18. The resin sheet 80 prevents shorting and liquid junction between the first and second metal layers 310, 320 and the second conductive plate 19.

The resin sheet 80 is formed by a resin material having an insulation property. The resin sheet 80 is formed by a resin material that can be welded to the resin sheet 50 and the first and second laminate sheet portions 21, 22. In detail, the resin sheet 80 is welded to the resin layer 53, and a sealant resin layer 312 (FIG. 2) and a fourth resin layer 324 (FIG. 3) described later. The resin sheet 80 at least includes an acid-modified PP (PPa) layer. In this example, the resin sheet 80 has a layer configuration similar to that of the resin sheet 50.

A central portion of the first conductive plate 18 and a central portion of the second conductive plate 19 are exposed regions that are not covered by the resin sheet 50, the first laminate sheet portion 21, and the second laminate sheet portion 22. Current can be directly taken from the electricity storage module 1 housed on the inside to the outside via the exposed regions.

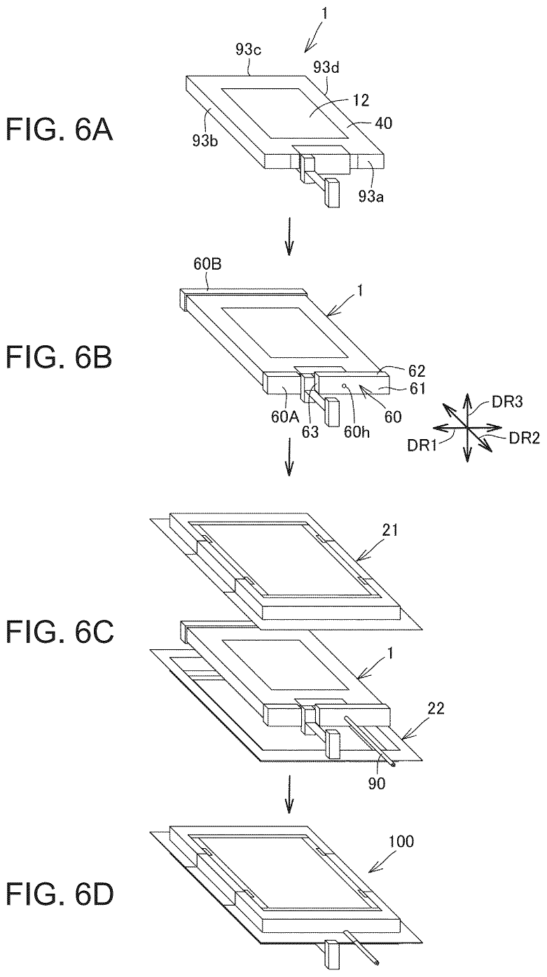

The first laminate sheet portion 21 includes a plurality of first sheets 31 and a plurality of second sheets 32 (see FIG. 2, FIG. 3, FIG. 6A, FIG. 6B, FIG. 6C, and FIG. 6D). The plurality of first sheets 31 and the plurality of second sheets 32 cover the peripheral edge of the first conductive plate 18 in cooperation with each other. The second laminate sheet portion 22 includes the plurality of first sheets 31 and the plurality of second sheets 32. The plurality of first sheets 31 and the plurality of second sheets 32 included in the second laminate sheet portion 22 cover the peripheral edge of the second conductive plate 19 in cooperation with each other.

The first sheet 31 (see FIG. 2) has the first metal layer 310 and sealant resin layers 311, 312. The first metal layer 310 has a sheet-like shape. In this example, as also shown in FIG. 5E described later, the first metal layer 310 is an aluminum foil (Al foil) layer. The first metal layer 310 is not limited to an Al foil and metal foils such as a Ni foil, a Cu foil, and a stainless steel foil can also be used. The first metal layer 310 gives moisture transmission resistance, air permeation resistance, and chemical resistance to the first sheet 31.

The sealant resin layers 311, 312 are provided on both surfaces of the first metal layer 310. Specifically, the sealant resin layer 311 is provided on an inner front surface of the first metal layer 310. The sealant resin layer 312 is provided on an outer front surface of the first metal layer 310.

The sealant resin layers 311, 312 have compatibility with the resin sheet 50. In this example, polypropylene (PP) is employed as the sealant resin layers 311, 312 but the present disclosure is not limited thereto, and a heat-fusible resin such as polyethylene, polypropylene, modified polyethylene, and modified polypropylene, for example, may be employed as the sealant resin layers 311, 312.

The sealant resin layers 311, 312 function as seal layers of the exterior body 20. The sealant resin layers 311, 312 also have a function as insulation layers and insulate the first laminate sheet portion 21 and the second laminate sheet portion 22 from each other when the first laminate sheet portion 21 and the second laminate sheet portion 22 are joined to each other.

The second sheet 32 (see FIG. 3) has a second metal layer 320, a first resin layer 321, a second resin layer 322, a third resin layer 323, and the fourth resin layer 324. In the second sheet 32, the third resin layer 323, the first resin layer 321, the second metal layer 320, the second resin layer 322, and the fourth resin layer 324 are stacked in the stated order from the inner side to the outer side of the stack-type battery 100. The fourth resin layer 324 is an outermost layer in the second sheet 32.

In this example, as also shown in FIG. 5F described later, the second metal layer 320 is an Al foil layer. The first resin layer 321 is an acid-modified PP (PPa) layer. The second resin layer 322 is a nylon layer. The third resin layer 323 is a polypropylene (PP) layer. The fourth resin layer 324 that is the outermost layer is a polyethylene terephthalate (PET) layer. The first resin layer 321 is provided on a first main surface 320a. The second resin layer 322 is provided on a second main surface 320b.

The second metal layer 320 has a sheet-like shape. The second metal layer 320 has the first main surface 320a and the second main surface 320b. The first main surface 320a is a surface that faces the inner side (the side on which the stacked electrode body 10 is positioned), and the second main surface 320b is a surface that faces the outer side (the opposite side from the side on which the stacked electrode body 10 is positioned).

The second metal layer 320 is not limited to an Al foil and metal foils such as a Ni foil, a Cu foil, and a stainless steel foil can be used. The thickness of the second metal layer 320 may be thicker than the thickness of the first metal layer 310. The thickness of the second metal layer 320 may be the same as the thickness of the first metal layer 310.

The third resin layer 323 has compatibility with the sealant resin layer 312. As the third resin layer 323, heat-fusible resin such as polyethylene, modified polyethylene, and modified polypropylene, for example, can be employed besides polypropylene (PP). It is preferred that a resin material having immiscibility against the sealant resin layer 312 be used in the fourth resin layer 324.

In the second sheet 32, a nylon layer (second resin layer 322) and a polyethylene terephthalate layer (fourth resin layer 324) are caused to overlap on the outer side of the second metal layer 320. Therefore, the combination of the layers on the outer side of the second metal layer 320 has a higher strength than the combination of the two layers (the first resin layer 321 and the third resin layer 323) on the inner side of the second metal layer 320 in the second sheet 32. The expression of “high strength” means that the rigidity or the tensile strength is high. As a result, the damage of the second metal layer 320 when the second sheet 32 receives force from the outside such as piercing can be suitably prevented.

The sealant resin layer 312 of the first sheet 31 (see FIG. 2) is a polypropylene (PP) layer as described above. Therefore, the combination of the layers on the outer side of the second metal layer 320 of the second sheet 32 has a higher strength than the sealant resin layer 312 of the first sheet 31. Therefore, the combination of the layers on the outer side of the second metal layer 320 in the second sheet 32 has a higher strength than the sealant resin layer 312 of the first sheet 31. By enhancing the strength of the second sheet 32, the damage of the second sheet 32 at the time of deep-drawing molding described later can be suitably prevented.

The first laminate sheet portion 21 is deep-drawing molded in a state of being joined to the first conductive plate 18. In other words, a drawing process is applied to the first laminate sheet portion 21. As a result, the first laminate sheet portion 21 has a shape that is opened toward the upper side and the lower side. A flange portion 21f bent to the outer side is provided on an opening end of the first laminate sheet portion 21 on the lower side thereof.

The second laminate sheet portion 22 is deep-drawing molded in a state of being joined to the second conductive plate 19. In other words, a drawing process is also applied to the second laminate sheet portion 22 as with the first laminate sheet portion 21. As a result, the second laminate sheet portion 22 has a shape that is opened toward the upper side and the lower side. A flange portion 22f bent to the outer side is provided on an opening end of the second laminate sheet portion 22 on the upper side thereof.

Housing recessed portions 21c, 22c for housing the electricity storage module 1 on the inner side are provided on the first laminate sheet portion 21 and the second laminate sheet portion 22. A part of the first main surface 91, a part of the second main surface 92, and the peripheral surfaces 93 in the electricity storage module 1 are covered by the housing recessed portions 21c, 22c.

In detail, a peripheral edge portion of an upper surface and a peripheral edge portion of a lower surface of the electricity storage module 1 and a peripheral surface of the electricity storage module 1 are covered by the housing recessed portions 21c, 22c. In detail, a peripheral edge portion of an upper surface and a peripheral edge portion of a lower surface of the stacked electrode body 10 and a peripheral surface of the stacked electrode body 10 are covered by the housing recessed portions 21c, 22c. A central portion of the upper surface of the stacked electrode body 10 is covered by the first conductive plate 18. A central portion of the lower surface of the stacked electrode body 10 is covered by the second conductive plate 19.

The housing recessed portions 21c, 22c are configured by a section formed by applying the drawing process described above to the first laminate sheet portion 21 and the second laminate sheet portion 22, for example. The housing recessed portions 21c, 22c are not limited to the section and only need to be provided to be able to house the stacked electrode body 10. In the description above, a case in which the housing recessed portions are provided in both of the first laminate sheet portion 21 and the second laminate sheet portion 22 has been exemplified, but the housing recessed portion may be provided in only one of the first laminate sheet portion 21 and the second laminate sheet portion 22.

The first sheet 31 has an inner-side end portion 31i positioned on the central side of the stacked electrode body 10. The second sheet 32 has an inner-side end portion 32i positioned on the central side of the stacked electrode body 10. The resin sheet 50 has an inner edge portion 50i and an outer edge portion 50c positioned on the central side of the stacked electrode body 10.

The inner edge portion 50i is positioned to be closer to the central side of the stacked electrode body 10 than the inner-side end portions 31i, 32i in order to secure an insulation distance between the first metal layer 310 included in the first sheet 31 and the second metal layer 320 included in the second sheet 32, and the first conductive plate 18 and the second conductive plate 19.

The first conductive plate 18 has an outer edge portion 18c. The second conductive plate 19 has an outer edge portion 19c. The inner-side end portions 31i, 32i are positioned to be closer to the central side of the stacked electrode body 10 than the outer edge portions 18c, 19c.

Parts in which the first conductive plate 18 and the second conductive plate 19 and the resin sheet 50 overlap are welded. Joining interfaces of the overlapping parts are sealed.

The outer edge portion 50c of the resin sheet 50 is positioned on the outer side of the outer edge portions 18c, 19c but is not limited thereto, and the outer edge portion 50c and the outer edge portions 18c, 19c may be flush with each other.

By joining the first sheet 31 and the second sheet 32 to the first conductive plate 18 and the second conductive plate 19 via the resin sheet 50, cases in which the first conductive plate 18 and the second conductive plate 19 short via the first sheet 31 having the first metal layer 310 or the second sheet 32 having the second metal layer 320 are reduced.

Next, the structure body 60 is described. As described above, the structure body 60 is housed in the exterior body 20. As shown in FIG. 3, the structure body 60 is disposed in a state of facing the peripheral surfaces 93 (in detail, the end surfaces 93a, 93c) of the electricity storage module 1.

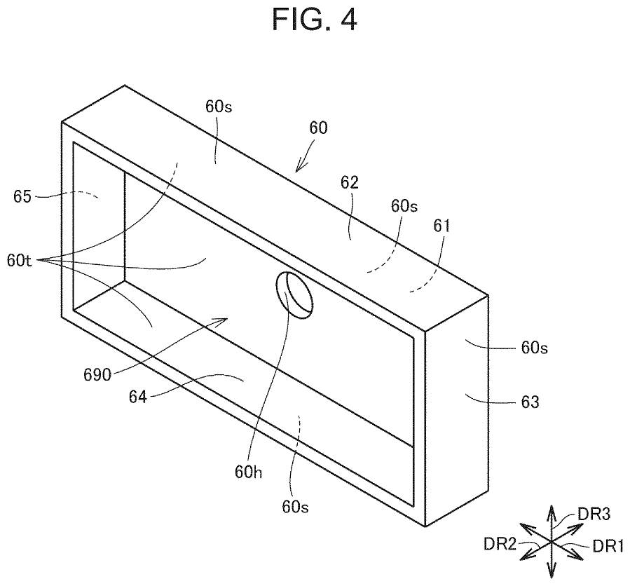

FIG. 4 is a perspective view of the structure body 60. As shown in FIG. 4, the structure body 60 has a box-like shape in this example. The structure body 60 is typically formed by resin. The structure body 60 includes a base portion 61 extending in the DR3 direction in side view (see FIG. 3) of the electricity storage module 1.

The structure body 60 further includes two wall portions 62, 64 extending from the base portion 61 to be parallel to the first main surface 91 of the electricity storage module 1 and to be in the DR2 direction toward the peripheral surfaces 93. The structure body 60 further includes two wall portions 63, 65 extending from the base portion 61 to be perpendicular to the first main surface 91 and to be in the DR2 direction toward the peripheral surfaces 93.

The wall portions 62, 63, 64, 65 that rise from the base portion 61 are continuous with each other in the stated order. The wall portion 62 is positioned on the first conductive plate 18 side. The wall portion 64 is positioned on the second conductive plate 19 side. A cuboid space 690 having an opening portion is formed by the base portion 61 and each of wall portions 62, 63, 64, 65.

The structure body 60 has outer front surfaces 60s and inner front surfaces 60t on the peripheral surface 93 side of the outer front surfaces 60s. In the structure body 60, a through-hole 60h that passes through the structure body 60 from the inner front surface 60t to the outer front surface 60s is formed. In detail, in this example, the through-hole 60h is formed in the base portion 61. The through-hole 60h is formed in a central portion of the base portion 61 in the DR2 direction.

The first and second laminate sheet portions 21, 22 (see FIG. 1) configuring the exterior body 20 are disposed so as to cover the outer front surfaces 60s of the structure body 60. In detail, each of the second sheets 32 (see FIG. 3) of the first and second laminate sheet portions 21, 22 are disposed so as to cover the outer front surfaces 60s of the structure body 60.

As described above, the sealed inner space 800 (FIG. 3) is formed by each of the second sheets 32 of the first and second laminate sheet portions 21, 22 between the inner front surface 60t of the part of the base portion 61 in the structure body 60 and the end surface 93a of the electricity storage module 1. The inner space 800 is depressurized so as to have a negative pressure with respect to the air pressure (the atmospheric pressure in this example) of an outer space of the stack-type battery 100. In this example, the inner space 800 is depressurized to about 1 kilopascal (kPa) in the initial state. The inner space 800 is placed in a low-vacuum state by vacuum drawing. A binding force is applied to the stacked electrode body 10 by the pressure (air pressure) difference between the inner space 800 and the outer space of the stack-type battery 100 generated by such depressurization.

As shown in FIG. 3, the piping 90 is caused to pass through the through-hole 60h. In this example, a distal end of the piping 90 reaches the inner space 800. An outer peripheral surface of the piping 90 is in contact with a wall surface of the through-hole 60h. A part of the piping 90 is sandwiched between the second sheet 32 of the first laminate sheet portion 21 and the second sheet 32 of the second laminate sheet portion 22. The third resin layer 323 that is an innermost layer of each of the second sheets 32 is welded to the outer peripheral surface of the piping 90.

The suction machine 910 suctions air in the inner space 800 of the stack-type battery 100 via the piping 90. The pressure gauge 920 measures the air pressure of the inner space 800 of the stack-type battery 100 by measuring the air pressure on the inside of the piping 90. The pressure gauge 920 notifies the suction machine 910 of the measured air pressure by a signal line (not shown).

The control apparatus 912 controls the suction pump 911. The control apparatus 912 controls the operation of the suction pump 911 on the basis of a program stored in a memory (not shown). The control apparatus 912 receives the value of the air pressure measured by the pressure gauge 920 from the pressure gauge 920.

The control apparatus 912 causes the suction pump 911 to operate when the value of the air pressure exceeds a threshold value Th1. The control apparatus 912 stops the suction pump 911 when the value of the air pressure becomes equal to or less than a threshold value Th2 lower than the threshold value Th1. As above, the control apparatus 912 controls the operation of the suction pump 911 such that a value (hereinafter P) indicated by the pressure gauge 920 falls within a predetermined range (threshold value Th1≥P≥threshold value Th2). The threshold value Th1 is a value (for example, 5 kPa) that is sufficiently lower than the atmospheric pressure (about 101.325 kPa). The threshold value Th2 is 1 kPa, for example.

As above, the stack-type battery 100 includes: the electricity storage module 1 having the stacked electrode body 10; the exterior body 20 that houses the electricity storage module 1 and forms a sealed inner space 800 between the exterior body 20 and the electricity storage module 1; and the piping 90 that discharges gas contained in the inner space 800 to the outside of the stack-type battery 100. In the stack-type battery 100, the air pressure of the inner space 800 is maintained to be a negative pressure with respect to the air pressure of the outer space of the stack-type battery 100 by the suction apparatus 900 that suctions gas via the piping 90.

There is a risk that air (nitrogen, oxygen, and the like) enters the inner space 800 of the stack-type battery 100 from the outside of the stack-type battery 100. For example, when there is a problem in the welding between the first laminate sheet portion 21 and the second laminate sheet portion 22, air may enter from a gap between the flange portion 21f and the flange portion 22f.

However, in the stack-type battery 100, even when air enters the inner space 800, the air in the inner space 800 is suctioned by the piping 90 and the suction apparatus 900, and hence the air pressure of the inner space 800 does not become a negative pressure with respect to the air pressure of the outer space. Therefore, it becomes possible to continue to apply a suitable binding force to the stacked electrode body 10 even when air enters the inner space 800 of the stack-type battery 100 from the outer space of the stack-type battery 100.

In detail, the stack-type battery 100 has a configuration as below when the first main surface 91 out of the first main surface 91 and the second main surface 92 is focused on. The electricity storage module 1 has the first main surface 91 and the peripheral surfaces 93 perpendicular to the first main surface 91. As shown in FIG. 3, the stack-type battery 100 further includes the structure body 60 housed in the exterior body 20. As shown in FIG. 4, the structure body 60 has the outer front surfaces 60s and the inner front surfaces 60t on the peripheral surface 93 side of the outer front surfaces 60s and is disposed in a state of facing the peripheral surfaces 93. The exterior body 20 further includes the second sheet 32 disposed so as to cover the outer front surfaces 60s. The inner space 800 is formed between the inner front surfaces 60t and the peripheral surfaces 93 by sealing by the second sheet 32. In the structure body 60, the through-hole 60h that passes through the structure body 60 from the outer front surface 60s to the inner front surface 60t is formed. The piping 90 reaches the inner space 800 via the through-hole 60h.

According to such configuration, the air in the inner space 800 can be suctioned via the piping 90. Cases in which the piping 90 is closed in the exterior body 20 can be reduced by the structure body 60.

In more detail, the stack-type battery 100 includes the suction apparatus 900. The suction apparatus 900 has the suction pump 911 that suctions gas contained in the inner space 800 via the piping 90, the control apparatus 912 that controls the operation of the suction pump 911, and the pressure gauge 920 that measures the air pressure in the piping 940. The control apparatus 912 controls the operation of the suction pump 911 such that the air pressure measured by the pressure gauge 920 at least becomes equal to or less than the threshold value Th1 lower than the air pressure of the outer space. According to such configuration, the air pressure of the inner space 800 can be maintained to be equal to or less than the threshold value Th1 lower than the air pressure of the outer space.

FIG. 5A, FIG. 5B, FIG. 5C, FIG. 5D, FIG. 5E, FIG. 5F, and FIG. 5G are views for describing a manufacturing method of the first laminate sheet portion 21. As shown in FIG. 5A, an aluminum plate that serves as the first conductive plate 18 is prepared. As shown in FIG. 5B, two resin sheets 50 are welded along two long edges of the aluminum plate. Next, as shown in FIG. 5C, two resin sheets 50 are welded along two short edges of the aluminum plate. The resin sheets 50 on the long edge side and the resin sheets 50 on the short edge side overlap at four corner portions shown in FIG. 5C.

As shown in FIG. 5D, two resin sheets 70 are welded to each of the two resin sheets 50 on the long edge side. Each of the resin sheets 70 has the same layer structure as the resin sheet 50 in this example. The two resin sheets 70 on the right side of the drawing are spaced apart from each other in the DR2 direction and extend in the DR1 direction. Similarly, the two resin sheets 70 on the left side of the drawing are also spaced apart from each other in the DR2 direction and extend in the DR1 direction. The four resin sheets 70 are welded to the resin sheets 50 on the long edge side in a state of sticking out from the resin sheets 50 in directions on the sides opposite from the aluminum plate.

As shown in FIG. 5E, one first sheet 31 is welded to the resin sheet 50 and the two resin sheets 70 on the right side of the drawing. Similarly, one first sheet 31 is also welded to the resin sheet 50 and the two resin sheets 70 on the left side of the drawing. Each first sheet extends in the DR2 direction. Each first sheet is longer than a separation distance between the resin sheets 70 in the DR2 direction.

As shown in FIG. 5F, one second sheet 32 is welded to the resin sheet 50 on the upper side in the drawing, the two resin sheets 70 on the upper side in the drawing, and end portions (end portions on the upper side in the drawing) of the two first sheets 31. The second sheet 32 has a U-like shape. Similarly, one second sheet 32 is also welded to the resin sheet 50 on the lower side in the drawing, the two resin sheets 70 on the lower side in the drawing, and end portions (end portions on the lower side in the drawing) of the two first sheets 31. The second sheets 32 are placed in a state of facing the DR2 direction by being spaced apart from each other. An intermediate body of the first laminate sheet portion 21 shown as FIG. 5F is line-symmetric in each of the DR1 direction and the DR2 direction. By applying a drawing process to the intermediate body along a virtual line L, the first laminate sheet portion 21 is generated as shown in FIG. 5G. By the drawing process, the flange portion 21f of the first laminate sheet portion 21 is formed.

The first laminate sheet portion 21 and the second laminate sheet portion 22 have the same shape. The second laminate sheet portion 22 is also manufactured by a method similar to that of the first laminate sheet portion 21. Therefore, here, the description of the manufacturing method of the second laminate sheet portion 22 is not repeated.

FIG. 6A, FIG. 6B, FIG. 6C, and FIG. 6D are views for describing the method of manufacturing the stack-type battery 100 by the electricity storage module 1 and the exterior body 20. As shown in FIG. 6A and FIG. 6B, the structure body 60 is installed on one of the two short edge sides of the electricity storage module 1. The structure body 60 is installed in a position facing the end surface 93a configuring the peripheral surfaces 93 of the electricity storage module 1.

In this example, the stack-type battery 100 further includes structure bodies 60A, 60B. The structure bodies 60A, 60B have structures and functions similar to those of the structure body 60. However, the through-hole 60h is not formed in the structure bodies 60A, 60B. The length of the structure body 60A in the DR1 direction is shorter than that of the structure body 60. The length of the structure body 60B in the DR1 direction is longer than that of the structure body 60. As with the structure body 60, the structure bodies 60A, 60B are housed in the exterior body 20.

The structure body 60A is installed on the same side as the structure body 60. As with the structure body 60, the structure body 60A is installed such that the opening side faces the end surface 93a. The structure body 60B is installed on a short edge on the opposite side from the structure body 60. The structure body 60B is installed in a position that faces the end surface 93c of the electricity storage module 1. In detail, the structure body 60B is installed such that the opening side faces the end surface 93c.

As shown in FIG. 6C, the piping 90 is caused to pass through the through-hole 60h in the structure body 60. The electricity storage module 1 and the three structure bodies 60, 60A, 60B are sandwiched by the first laminate sheet portion 21 and the second laminate sheet portion 22. The second laminate sheet portion 22 is in a state of facing down. Then, the first laminate sheet portion 21 and the second laminate sheet portion 22 are welded to each other. As a result, the stack-type battery 100 is completed as shown in FIG. 6D.

### Modified Examples

In the description above, a configuration in which the stack-type battery 100 includes the piping 90 and the suction apparatus 900 has been described. A configuration in which a plurality of the stack-type batteries 100 shares a suction apparatus is described below.

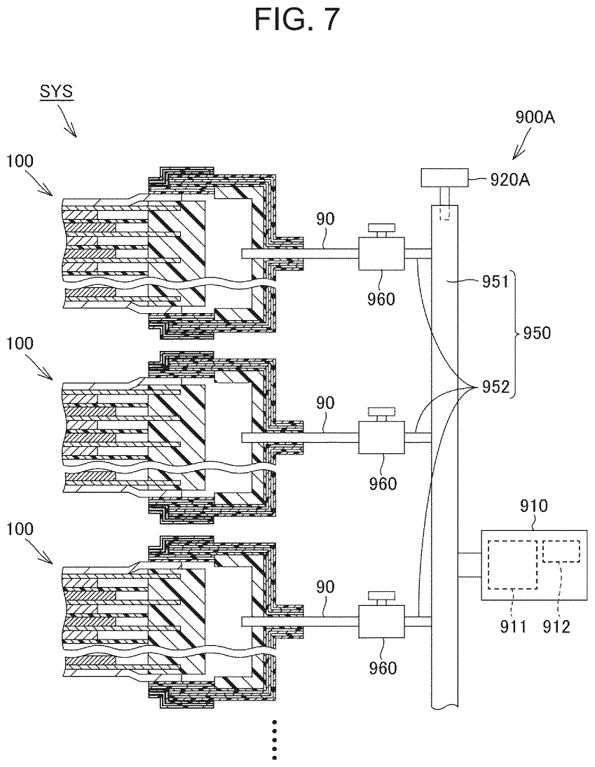

FIG. 7 is a view for describing an electricity storage system SYS. As shown in FIG. 7, the electricity storage system SYS includes the plurality of stack-type batteries 100 and a suction apparatus 900A.

The suction apparatus 900A has a suction machine 910, a pressure gauge 920A, piping 950, and a plurality of valves 960.

The piping 950 connects the piping 90 of the stack-type battery 100 and the suction pump 911 of the suction apparatus 900 to each other. The piping 950 has one main pipe 951 and a plurality of branch pipes 952. Each of the branch pipes 952 is joined to the main pipe 951. The suction pump 911 is connected to the main pipe 951. Each of the branch pipes 952 is connected to each of the valves 960 that are different from each other. Each of the valves 960 is connected to each of the piping 90 that is different from each other. One piping 90 and one branch pipe 952 are joined to each other by one valve 960.

The pressure gauge 920A measures the air pressure in the piping 950. The pressure gauge 920A measures the air pressure in the main pipe 951. When each of the valves 960 is in an open state, the pressure gauge 920A measures an average of the air pressure of the inner spaces 800 of the plurality of stack-type batteries 100.

The suction pump 911 can suction gas contained in the inner space 800 of each of the stack-type batteries 100 via each piping 90 and the piping 950. In detail, when each of the valves 960 is in an open state, the suction pump 911 can suction the gas contained in each of the inner spaces 800.

In this example, the control apparatus 912 controls the operation of the suction pump 911 such that the air pressure measured by the pressure gauge 920A at least becomes equal to or less than the threshold value Th1 lower than the air pressure of the outer space. In detail, the control apparatus 912 causes the suction pump 911 to operate when the value of the air pressure measured by the pressure gauge 920A exceeds the threshold value Th1. The control apparatus 912 stops the suction pump 911 when the value of the air pressure becomes equal to or less than the threshold value Th2 lower than the threshold value Th1. As above, the control apparatus 912 controls the operation of the suction pump 911 such that the value P indicated by the pressure gauge 920A falls within a predetermined range (threshold value Th1≥P≥threshold value Th2).

According to such configuration, the inner space 800 of each of the stack-type batteries 100 can be simultaneously depressurized by one suction pump 911. Therefore, the air pressure of the inner space 800 of each of the stack-type batteries 100 can be maintained to be equal to or less than the threshold value Th1 lower than the air pressure of the outer space.

Each of the valves 960 may have a configuration that automatically opens and closes on the basis of an instruction from the control apparatus 912. In the case of such configuration, the control apparatus 912 controls the opening and closing of each of the valves such that only one valve 960 out of the plurality of valves 960 is successively placed in an open state. The control apparatus 912 controls the operation of the suction pump 911 such that the air pressure of the inner space 800 measured by the pressure gauge 920A becomes equal to or less than the threshold value Th1. According to such configuration, the air pressure of each of the inner spaces 800 can be individually measured by the pressure gauge 920A, and the air pressure of each of the inner spaces 800 can be individually set to be equal to or less than the threshold value Th1.

The embodiment disclosed above is merely an example in all aspects and is in no way intended to limit the disclosure. The scope of the disclosure is defined by the scope of claims. All modifications made within the scope and spirit equivalent to those of the claims are included in the disclosure.

What is claimed is:

1. An electricity storage apparatus, comprising:
an electricity storage module having a stacked electrode body;
an exterior body that houses the electricity storage module and forms a sealed inner space between the exterior body and the electricity storage module; and
first piping that discharges gas contained in the inner space to an outside of the electricity storage apparatus, wherein an air pressure of the inner space of the electricity storage apparatus is maintained to be a negative pressure with respect to an air pressure of an outer space of the electricity storage apparatus by a suction apparatus that suctions the gas via the first piping.

2. The electricity storage apparatus according to claim 1, further comprising a structure body housed in the exterior body, wherein:
the electricity storage module has a main surface and a peripheral surface perpendicular to the main surface;
the structure body has an outer front surface and an inner front surface on the peripheral surface side of the outer front surface and is disposed in a state of facing the peripheral surface;
the exterior body includes a laminate sheet body disposed so as to cover the outer front surface;
the inner space is formed between the inner front surface and the peripheral surface by sealing by the laminate sheet body;
a through-hole that passes through the structure body from the outer front surface to the inner front surface is formed in the structure body; and
the first piping reaches the inner space via the through-hole.

3. The electricity storage apparatus according to claim 1, further comprising the suction apparatus, wherein:
the suction apparatus includes:
a pump that suctions the gas contained in the inner space via the first piping;
a control apparatus that controls an operation of the pump; and
a pressure gauge that measures an air pressure in the first piping; and
the control apparatus controls the operation of the pump such that the air pressure measured by the pressure gauge becomes equal to or less than a threshold value lower than the air pressure of the outer space.

4. An electricity storage system, comprising a plurality of the electricity storage apparatuses according to claim 1, the electricity storage system further comprising the suction apparatus, wherein:
the suction apparatus includes:
a pump;
second piping that connects the first piping of each of the electricity storage apparatuses and the pump to each other;
a control apparatus that controls an operation of the pump; and
a pressure gauge that measures an air pressure in the second piping;
the pump is able to suction the gas contained in the inner space of each of the electricity storage apparatuses via the first piping and the second piping; and
the control apparatus controls the operation of the pump such that the air pressure measured by the pressure gauge becomes equal to or less than a threshold value lower than the air pressure of the outer space.
